(19) United States
(12) Patent Application Publication
(10) Pub. No.: US 2020/0063066 A1
(43) Pub. Date: Feb. 27, 2020

(54) PROCESS OF REDUCING MALODOURS ON FABRICS

(71) Applicant: The Procter & Gamble Company, Cincinnati, OH (US)

(72) Inventors: Karel Jozef Maria DEPOOT, Anzegem-Vichte (BE); Hilde Francoise Louise ANDRIESSEN, Mol (BE); Sherri Lynn Randall, Hamilton, OH (US); Gregory Scot Miracle, Liberty Township, OH (US); Patrick Christopher STENGER, Fairfield, OH (US); Giulia Ottavia BIANCHETTI, Brussels (BE)

(21) Appl. No.: 16/543,660

(22) Filed: Aug. 19, 2019

(30) Foreign Application Priority Data
Aug. 24, 2018 (EP) 18190611.6

(51) Int. Cl. C11D 3/30; C11D 11/00; C11D 3/00; C11D 1/83; C11D 9/00; C11D 9/30

(52) U.S. Cl. CPC C11D 3/30; C11D 11/0017; C11D 3/0068; C11D 3/0084; C11D 9/002; C11D 9/30; C11D 1/83

(57) ABSTRACT

A process for reducing malodours on fabrics using a detergent composition including an oligoamine. U of the oligoamine and the process.

### FIELD OF THE INVENTION

The present disclosure relates to a process for reducing malodours on fabrics using a detergent composition containing an oligoamine, and use of the oligoamine and the process.

### BACKGROUND OF THE INVENTION

Laundry wash processes are designed to eliminate soils from fabrics. Some soils can cause malodours on fabrics and in some instances these malodours can persist even after the laundry wash operation.

Therefore, there is an on-going need for processes to reduce malodours on fabrics.

It was surprisingly found that the process according to the present invention provided reduced malodours on fabrics.

Without wishing to be bound by theory, it is believed that it is the combination of the specific choice of oligoamine according to the present invention in combination with a metal ion that provides the reduced malodour benefit on the fabrics through the wash.

### SUMMARY OF THE INVENTION

The present disclosure relates to a process of reducing malodours on fabrics, comprising the steps of;
a. Combining fabrics with a wash liquor, wherein the fabrics comprise at least one source of malodour and wherein the wash liquor comprises a source of metal ions, preferably Cu²⁺ and wherein the wash liquor is prepared by diluting a laundry detergent composition in water by a factor of between 100 and 3000 fold, preferably between 300 and 900 fold;
b. Washing the fabrics in the wash liquor using an automatic wash operation, a manual wash operation of a mixture thereof, preferably an automatic wash operation;
c. Separating the fabrics and the wash liquor from one another;
d. Drying the fabrics;
where the laundry detergent composition comprises between 0.01% to 5% by weight of the laundry detergent composition of an oligoamine or salt thereof, wherein the oligoamine has the following formula;

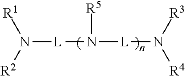

wherein;
each L is independently —(CₘH₂ₘ)—, wherein the index m is independently for each L an integer from 2 to 6, preferably from 2 to 3, most preferably 2;
n is an integer from 1 to 10, preferably from 1 to 5, more preferably 1 to 3, more preferably 1 to 2; and
each of R¹-R⁵ is independently selected from H and C₁-C₄ alkyl, preferably H and methyl, more preferably H.

The present disclosure also relates to the use of an oligoamine or salt thereof to reduce malodours on fabrics wherein the fabric comprises at least one source of malodour and the oligoamine or salt thereof has the following formula;

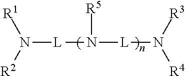

wherein;
each L is independently —(CₘH₂ₘ)—, wherein the index m is independently for each L an integer from 2 to 6, preferably from 2 to 3, most preferably 2;
n is an integer from 1 to 10, preferably from 1 to 5, more preferably 1 to 3, more preferably 1 to 2; and
each of R¹-R⁵ is independently selected from H and C₁-C₄ alkyl, preferably H and methyl, more preferably H.

The present disclosure also relates to a use of a process according to the present disclosure to reduce malodour on fabrics in a wash liquor and wherein the fabrics comprise at least one source of malodour and wherein the wash liquor comprises a metal ion, preferably Cu²⁺.

### BRIEF DESCRIPTION OF THE DRAWINGS

FIG. 1 is a water-soluble unit dose article according to the present invention.

### DETAILED DESCRIPTION OF THE INVENTION

### Process

The present disclosure relates to a process of reducing malodours on fabrics.

A ‘malodour’ in the context of the present invention is an undesired or undesirable smell on the fabrics. Those skilled in the art will be aware of what an undesirable smell is as compared to a desirable smell.

The process comprises the steps of;
a. Combining fabrics with a wash liquor, wherein the fabrics comprise at least one source of malodour and wherein the wash liquor comprises a source of metal ions, preferably Cu²⁺ and wherein the wash liquor is prepared by diluting a laundry detergent composition in water by a factor of between 100 and 3000 fold, preferably between 300 and 900 fold. The fabric may be any suitable fabric. By fabric we preferably mean a textile or cloth comprising a network of natural or synthetic fibers. Those skilled in the art will be aware of suitable fabrics. The fabric may be selected from cotton, polyester, cotton/polyester blends, polyamide, lycra, rayon, or a mixture thereof.

The fabric comprises at least one source of malodour. Those skilled in the art will be aware of suitable sources of malodour. Sources of malodour could include the products of chemical breakdown of body soils. The source of malodour may comprise 6-Methyl-5-heptane-2-one, Trans-2-heptanal, 3-methyl-2-Butenal, Decanoic Acid, Undecanoic Acid, Undecanal or a mixture thereof.

Those skilled in the art will know how to make the wash liquor. Without wishing to be bound by theory, addition of the laundry detergent composition to water will cause the laundry detergent composition to dissolve and create the wash liquor.

The wash liquor can be created automatically in the drum of an automatic washing machine or can be made in a manual wash operation.

The laundry detergent composition may be comprised in a water-soluble unit dose article, wherein the water-soluble unit dose article comprises a water-soluble film. Without wishing to be bound by theory, addition of the water-soluble unit dose article to water will cause the water-soluble film to dissolve and release the laundry detergent composition into the water creating the main wash liquor. The wash liquor can be created automatically in the drum of an automatic washing machine or can be made in a manual wash operation. When made in the drum of an automatic washing machine, traditionally, the fabrics to be washed and the water-soluble unit dose article are added to the drum and the door of the washing machine closed. The washing machine then automatically adds water to the drum to create the wash liquor.

Preferably the wash liquor comprises between 1 L and 64 L, preferably between 2 L and 32 L, more preferably between 3 L and 20 L of water.

The laundry detergent composition is described in more detail below.

The wash liquor comprises a metal ion, preferably Cu²⁺. The metal ion may be present on the fabric before the fabric is contacted with the wash liquor. The metal ion may be present in the source of malodour on the fabric before the fabric is combined to the wash liquor. The metal ion may be present in the wash liquor when combined with the fabric. If present in the wash liquor, the metal ion may be present in the laundry detergent, the water or a mixture thereof. The water used to make the wash liquor may comprise between 1 ppm and 10,000 ppm, preferably between 10 ppm and 5000 ppm of the metal ion. Without wishing to be bound by theory, tap water comprises between 1 ppm and 10,000 ppm, preferably between 10 ppm and 5000 ppm of Cu²⁺. The source of malodour may comprise the metal ion at the point the source of malodour is applied to the fabric. Alternatively, the source of malodour may be applied to the fabric and the metal ion applied later.

Preferably, the wash liquor comprises from 0.1 ppm to 100 ppm, preferably from 0.15 ppm to 50 ppm of the oligoamine
b. Washing the fabrics in the wash liquor using an automatic wash operation, a manual wash operation of a mixture thereof, preferably an automatic wash operation.

Those skilled in the art will know how to wash fabrics in an automatic wash operation, a manual wash operation or a mixture thereof.

Preferably, the wash liquor is at a temperature of between 5° C. and 90° C., preferably between 10° C. and 60° C., more preferably between 12° C. and 45° C., most preferably between 15° C. and 40° C.

Preferably, washing the fabrics in the wash liquor takes between 5 minutes and 50 minutes, preferably between 5 minutes and 40 minutes, more preferably between 5 minutes and 30 minutes, even more preferably between 5 minutes and 20 minutes, most preferably between 6 minutes and 18 minutes to complete.

Preferably, the wash liquor comprises between 1 kg and 20 kg, preferably between 3 kg and 15 kg, most preferably between 5 and 10 kg of the fabrics.

The wash liquor may comprise water of any hardness preferably varying between 0 gpg to 40 gpg. A lower water hardness is termed soft water whereas a higher water hardness is termed hard water.
c. Separating the fabrics and the wash liquor from one another.

The fabrics and the wash liquor are separated from one another following washing of the fabrics. Such separation may involve removing the fabrics from the wash liquor, or draining the wash liquor away from the fabrics. In an automatic washing machine operation it is preferred that the wash liquor is draining away from the fabrics. In the avoidance of doubt, some of the wash liquor may remain soaked into the fabrics following separation of the fabrics and the main wash liquor, i.e. the fabrics remain wet. With respect to the present invention the fabrics and wash liquor are deemed separated from one another once the fabric is separate from the main volume of the wash liquor or the mina volume of the wash liquor has been drained away, despite some residual wash liquor possibly remaining soaked into the fabrics.

d. Drying the fabrics.

Those skilled in the art will be aware of suitable means to dry the fabrics. The fabrics may be dried on a line at room temperature, in an automatic drying machine or a mixture thereof. Those skilled in the art will know at what point the fabrics are deemed dry as opposed to wet.

### Laundry Detergent Composition

The process according to the present invention comprises the step of diluting a laundry detergent composition.

The laundry detergent composition may be a powder, a liquid, a water-soluble unit dose particle or a mixture thereof, preferably a water-soluble unit dose comprising a liquid composition.

The solid laundry detergent composition may comprise solid particulates or may be a single homogenous solid. Preferably, the solid laundry detergent composition comprises particles. This means the solid laundry detergent composition comprises individual solid particles as opposed to the solid being a single homogenous solid. The particles may be free-flowing or may be compacted, preferably free-flowing.

The term ‘liquid laundry detergent composition’ refers to any laundry detergent composition comprising a liquid capable of wetting and treating a fabric, and includes, but is not limited to, liquids, gels, pastes, dispersions and the like. The liquid composition can include solids or gases in suitably subdivided form, but the liquid composition excludes forms which are non-fluid overall, such as powders, tablets or granules.

The water-soluble unit dose article is described in more detail below.

The laundry detergent composition comprises between 0.01% to 5%, more preferably from 0.03% to 1%, most preferably from 0.05% to 0.5% by weight of the laundry detergent composition of an oligoamine or salt thereof. The oligoamine or salt thereof is described in more detail below.

The laundry detergent composition preferably comprises a non-soap surfactant. More preferably, the non-soap surfactant is selected from non-soap anionic surfactant, non-ionic surfactant, amphoteric surfactant, cationic surfactant, or a mixture thereof. The laundry detergent composition preferably comprises between 10% and 60%, more preferably between 20% and 55% by weight of the laundry detergent composition of the non-soap surfactant.

Preferably, the non-soap anionic surfactant comprises linear alkylbenzene sulphonate, alkoxylated alkyl sulphate, alkyl sulfate, or a mixture thereof. Preferably, the alkyl sulphate is an ethoxylated alkyl sulphate.

Preferably, the laundry detergent composition comprises between 5% and 50%, preferably between 15% and 45%, more preferably between 25% and 40%, most preferably between 30% and 40% by weight of the detergent composition of the non-soap anionic surfactant.

Preferably, the non-soap anionic surfactant comprises linear alkylbenzene sulphonate and alkoxylated alkyl sulphate, wherein the ratio of linear alkylbenzene sulphonate to alkoxylated alkyl sulphate preferably the weight ratio of linear alkylbenzene sulphonate to ethoxylated alkyl sulphate is from 1:2 to 20:1, preferably from 1.1:1 to 15:1, more preferably from 1.2:1 to 10:1, even more preferably from 1.3:1 to 5:1, most preferably from 1.4:1 to 3:1.

Preferably, the laundry detergent composition comprises between 0% and 10%, preferably between 0.01% and 8%, more preferably between 0.1% and 6%, most preferably between 0.15% and 4% by weight of the laundry detergent composition of a non-ionic surfactant. The non-ionic surfactant is preferably selected from alcohol alkoxylate, an oxo-synthesized alcohol alkoxylate, Guerbet alcohol alkoxylates, alkyl phenol alcohol alkoxylates or a mixture thereof.

Preferably, the laundry preferably liquid laundry detergent composition comprises between 1.5% and 20%, more preferably between 2% and 15%, even more preferably between 3% and 10%, most preferably between 4% and 8% by weight of the laundry detergent composition of soap, preferably a fatty acid salt, more preferably an amine neutralized fatty acid salt, wherein preferably the amine is an alkanolamine more preferably selected from monoethanolamine, diethanolamine, triethanolamine or a mixture thereof, more preferably monoethanolamine.

The laundry detergent composition preferably comprises an ingredient selected from the list comprising cationic polymers, polyester terephthalates, amphiphilic graft co-polymers, carboxymethylcellulose, enzymes, perfumes, encapsulated perfumes, bleach or a mixture thereof. Without wishing to be bound by theory it is believed further addition of these materials can further facilitate malodor reduction.

The laundry detergent composition may comprise an adjunct ingredient, wherein the adjunct ingredient is selected from non-aqueous solvents, water, hueing dyes, aesthetic dyes, enzymes, cleaning polymers, builders like fatty acid, bleach, dispersants, dye transfer inhibitor polymers, fluorescent whitening agent, opacifier, antifoam or a mixture thereof.

Preferably, the laundry detergent composition comprises a chelant, wherein the chelant is preferably selected from phosphonates, aminocarboxylates, amino phosphonates, polyfunctionally-substituted aromatic chelating agents, or mixtures thereof, more preferably an additional chelating agent selected from DTPA (diethylenetriaminepentaacetic acid), HEDP (hydroxyethanediphosphonic acid), EDDS (ethylenediamine disuccinate (EDDS), DTPMP (diethylene triamine penta (methylene phosphonic acid)), EDTMP (ethylene diamine tetra(methylene phosphonic acid)), Tiron® (1,2-diydroxybenzene-3,5-disulfonic acid), HPNO (2-pyridinol-N-oxide), MGDA (methylglycinediacetic acid), GLDA (glutamic-N,N-diacetic acid), any suitable derivative thereof, salts thereof, and mixtures thereof.

The laundry detergent composition may comprise an antioxidant. Without wishing to be bound by theory, it is believed that antioxidants may help to improve malodor control and/or cleaning performance of the compositions, particularly in combination with the oligoamines of the present disclosure. Antioxidants may also help to reduce yellowing that may be associated with amines, allowing the amines to be formulated at a relatively higher level.

The laundry detergent composition may comprise a hindered phenol antioxidant in an amount of from 0.001% to 2%, preferably from 0.01% to 0.5%, by weight of the laundry detergent composition.

Suitable antioxidants may include alkylated phenols, having the general formula:

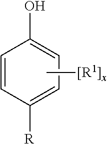

wherein R is C₁-C₂₂ linear alkyl or C₃-C₂₂ branched alkyl, each (1) having optionally therein one or more ester (—CO₂—) or ether (—O—) links, and (2) optionally substituted by an organic group comprising an alkyleneoxy or polyalkyleneoxy group selected from EO (ethoxy), PO (propoxy), BO (butoxy), and mixtures thereof, more preferably from EO alone or from EO/PO mixtures; R may preferably be methyl, branched C₃-C₆ alkyl, or C₁-C₆ alkoxy, preferably methoxy; R¹ is a C₃-C₆ branched alkyl, preferably tert-butyl; x is 1 or 2.

Preferred types of alkylated phenols having this formula may include hindered phenolic compounds. As used herein, the term “hindered phenol” is used to refer to a compound comprising a phenol group with either (a) at least one C₃ or higher branched alkyl, preferably a C₃-C₆ branched alkyl, preferably tert-butyl, attached at a position ortho to at least one phenolic —OH group, or (b) substituents independently selected from the group consisting of a C₁-C₆ alkoxy, preferably methoxy, a C₁-C₂₂ linear alkyl or C₃-C₂₂ branched alkyl, preferably methyl or branched C₃-C₆ alkyl, or mixtures thereof, at each position ortho to at least one phenolic —OH group. If a phenyl ring comprises more than one —OH group, the compound is a hindered phenol provided at least one such —OH group is substituted as described immediately above. Where any R group in the structure above comprises three or more contiguous monomers, that antioxidant is defined herein as a “polymeric hindered phenol antioxidant.” Compositions according to the present disclosure may include a hindered phenol antioxidant. A preferred hindered phenol antioxidant includes 3,5-di-tert-butyl-4-hydroxytoluene (BHT).

A further class of hindered phenol antioxidants that may be suitable for use in the composition is a benzofuran or benzopyran derivative having the formula:

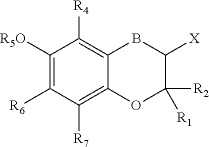

wherein R₁ and R₂ are each independently alkyl or R₁ and R₂ can be taken together to form a C₅-C₆ cyclic hydrocarbyl moiety; B is absent or CH₂; R₄ is C₁-C₆ alkyl; R₅ is hydrogen or —C(O)R₃ wherein R₃ is hydrogen or C₁-C₁₉ alkyl; R₆ is C₁-C₆ alkyl; R₇ is hydrogen or C₁-C₆ alkyl; X is —CH₂OH, or —CH₂A wherein A is a nitrogen-comprising unit, phenyl, or substituted phenyl. Preferred nitrogen-comprising A units include amino, pyrrolidino, piperidino, morpholino, piperazino, and mixtures thereof.

Suitable hindered phenol antioxidants may include: 2,6-bis(1,1-dimethylethyl)-4-methyl-phenol; 3,5-bis(1,1-dimethylethyl)-4-hydroxy-benzenepropanoic acid, methyl ester; 3,5-bis(1,1-dimethylethyl)-4-hydroxybenzenepropanoic acid, octadecyl ester; or mixtures thereof.

Commercially available antioxidants that may be suitable include BHT, RALOX 35™, and/or TINOGARD TS™.

Additional antioxidants may be employed. Examples of suitable antioxidants for use in the composition include, but are not limited to, the group consisting of □-, □-, □-, □-tocopherol, ethoxyquin, 2,2,4-trimethyl-1,2-dihydroquinoline, 2,6-di-tert-butyl hydroquinone, tert-butyl hydroxyanisole, lignosulphonic acid and salts thereof, and mixtures thereof. It is noted that ethoxyquin (1,2-dihydro-6-ethoxy-2,2,4-trimethylquinoline) is marketed under the name Raluquin™ by the company Raschig™. Other types of antioxidants that may be used in the composition are 6-hydroxy-2,5,7,8-tetramethylchroman-2-carboxylic acid (Trolox™) and 1,2-benzisothiazoline-3-one (Proxel GXL™). Antioxidants such as tocopherol sorbate, butylated hydroxyl benzoic acids and their salts, gallic acid and its alkyl esters, uric acid and its salts, sorbic acid and its salts, and dihydroxyfumaric acid and its salts may also be useful.

The use of non-yellowing antioxidants, such as non-yellowing hindered phenol antioxidants, may be preferred. Antioxidants that form such yellow by-products may be avoided if they lead to perceptible negative attributes in the consumer experience (such as deposition of yellow by-products on fabric, for example). The skilled artisan is able to make informed decisions regarding the selection of antioxidants to employ.

The liquid laundry detergent composition preferably has a pH between 6 and 10, more preferably between 6.5 and 8.9, most preferably between 7 and 8, wherein the pH of the liquid laundry detergent composition is measured as a 10% dilution in demineralized water at 20° C.

### Water-Soluble Unit Dose Article

The water-soluble unit dose article comprises a water-soluble film and a laundry detergent composition. The laundry detergent composition and the water-soluble film are described in more detail below.

The water-soluble unit dose article comprises the water-soluble film shaped such that the unit-dose article comprises at least one internal compartment surrounded by the water-soluble film, and wherein the laundry detergent composition is present within said compartment. The unit dose article may comprise a first water-soluble film and a second water-soluble film sealed to one another such to define the internal compartment. The water-soluble unit dose article is constructed such that the laundry detergent composition does not leak out of the compartment during storage. However, upon addition of the water-soluble unit dose article to water, the water-soluble film dissolves and releases the contents of the internal compartment into the wash liquor.

The compartment should be understood as meaning a closed internal space within the unit dose article, which holds the detergent composition. During manufacture, a first water-soluble film may be shaped to comprise an open compartment into which the detergent composition is added. A second water-soluble film is then laid over the first film in such an orientation as to close the opening of the compartment. The first and second films are then sealed together along a seal region.

The unit dose article may comprise more than one compartment, even at least two compartments, or even at least three compartments. The compartments may be arranged in superposed orientation, i.e. one positioned on top of the other. In such an orientation the unit dose article will comprise three films, top, middle and bottom. Alternatively, the compartments may be positioned in a side-by-side orientation, i.e. one orientated next to the other. The compartments may even be orientated in a ‘tyre and rim’ arrangement, i.e. a first compartment is positioned next to a second compartment, but the first compartment at least partially surrounds the second compartment, but does not completely enclose the second compartment. Alternatively, one compartment may be completely enclosed within another compartment.

Wherein the unit dose article comprises at least two compartments, one of the compartments may be smaller than the other compartment. Wherein the unit dose article comprises at least three compartments, two of the compartments may be smaller than the third compartment, and preferably the smaller compartments are superposed on the larger compartment. The superposed compartments preferably are orientated side-by-side.

In a multi-compartment orientation, the laundry detergent composition according to the present invention may be comprised in at least one of the compartments. It may for example be comprised in just one compartment, or may be comprised in two compartments, or even in three compartments.

Each compartment may comprise the same or different compositions. The different compositions could all be in the same form, or they may be in different forms.

The water-soluble unit dose article may comprise at least two internal compartments, wherein the liquid laundry detergent composition is comprised in at least one of the compartments, preferably wherein the unit dose article comprises at least three compartments, wherein the detergent composition is comprised in at least one of the compartments.

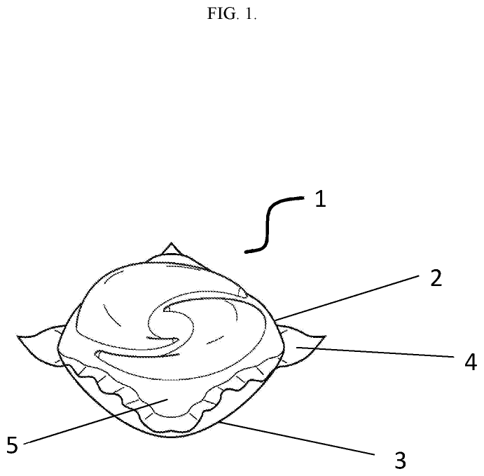

FIG. 1 discloses a water-soluble unit dose article (1) according to the present invention. The water-soluble unit dose article (1) comprises a first water-soluble film (2) and a second water-soluble film (3) which are sealed together at a seal region (4). The laundry detergent composition (5) is comprised within the water-soluble soluble unit dose article (1).

The film of the present invention is soluble or dispersible in water. The water-soluble film preferably has a thickness of from 20 to 150 micron, preferably 35 to 125 micron, even more preferably 50 to 110 micron, most preferably about 76 micron.

Preferably, the film has a water-solubility of at least 50%, preferably at least 75% or even at least 95%, as measured by the method set out here after using a glass-filter with a maximum pore size of 20 microns:

5 grams±0.1 gram of film material is added in a pre-weighed 3 L beaker and 2 L±5 ml of distilled water is added. This is stirred vigorously on a magnetic stirrer, Labline model No. 1250 or equivalent and 5 cm magnetic stirrer, set at 600 rpm, for 30 minutes at 30° C. Then, the mixture is filtered through a folded qualitative sintered-glass filter with a pore size as defined above (max. 20 micron). The water is dried off from the collected filtrate by any conventional method, and the weight of the remaining material is determined (which is the dissolved or dispersed fraction). Then, the percentage solubility or dispersability can be calculated.

Preferred film materials are preferably polymeric materials. The film material can, for example, be obtained by casting, blow-moulding, extrusion or blown extrusion of the polymeric material, as known in the art.

Preferred polymers, copolymers or derivatives thereof suitable for use as pouch material are selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. Preferably, the level of polymer in the pouch material, for example a PVA polymer, is at least 60%. The polymer can have any weight average molecular weight, preferably from about 1000 to 1,000,000, more preferably from about 10,000 to 300,000 yet more preferably from about 20,000 to 150,000.

Mixtures of polymers and/or copolymers can also be used as the pouch material, especially mixtures of polyvinylalcohol polymers and/or copolymers, especially mixtures of polyvinylalcohol homopolymers and/or anionic polyvinylalcohol copolymers preferably selected from sulphonated and carboxylated anionic polyvinylalcohol copolymers especially carboxylated anionic polyvinylalcohol copolymers. Most preferably the water soluble film comprises a blend of a polyvinylalcohol homopolymer and a carboxylated anionic polyvinylalcohol copolymer.

Preferred films exhibit good dissolution in cold water, meaning unheated distilled water. Preferably such films exhibit good dissolution at temperatures of 24° C., even more preferably at 10° C. By good dissolution it is meant that the film exhibits water-solubility of at least 50%, preferably at least 75% or even at least 95%, as measured by the method set out here after using a glass-filter with a maximum pore size of 20 microns, described above.

Preferred films are those supplied by Monosol under the trade references M8630, M8900, M8779, M8310.

The film may be opaque, transparent or translucent. The film may comprise a printed area.

The area of print may be achieved using standard techniques, such as flexographic printing or inkjet printing.

The film may comprise an aversive agent, for example a bittering agent. Suitable bittering agents include, but are not limited to, naringin, sucrose octaacetate, quinine hydrochloride, denatonium benzoate, or mixtures thereof. Any suitable level of aversive agent may be used in the film. Suitable levels include, but are not limited to, 1 to 5000 ppm, or even 100 to 2500 ppm, or even 250 to 2000 rpm.

### Oligoamine

The detergent composition according to the disclosure comprises an oligoamine or a salt thereof. Oligoamines according to the invention are comprising amine functions, preferably terminal primary amine and internal secondary amine functions, connected through specific alkylene groups, and are characterized by the following formula;

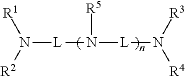

wherein

each L is independently —(CₘH₂ₘ)—, wherein the index m is independently for each L an integer from 2 to 6, preferably m is 2 or 3, more preferably m is 2 (e.g., ethylene groups);

n is an integer from 1 to 10 (i.e. triamines, tetramines, pentamines, hexamines, heptamines), preferably from 1 to 5, more preferably from 1 to 3, even more preferably from 1 to 2, most preferably 1; and

wherein each of R¹-R⁵ is independently selected from H and C₁-C₄ alkyl, preferably H and methyl (i.e., C₁ alkyl).

The index m may be independently for each L an integer from 2 to 6, wherein the index m is 2 or 3, preferably 2, for each of two L groups that are directly connected to a common N atom. It is believed that having two such L groups adjacent to a common N atom will facilitate improved metal sequestration, even if other L groups are relatively larger.

Each of R¹-R⁵ may be H. R⁵ may be methyl. R⁵ may be H. One or both of R¹ and R³ may be methyl. R¹ and R³ may be methyl, and R² and R⁴ may both be hydrogen. Each of R¹-R⁵ may be methyl. Most preferably each of R¹-R⁵ are H.

The present compositions may include an oligoamine having a structure according to the above formula, wherein L, m, n, and R¹-R⁵ are defined as above, with the proviso that if n is equal to 1, then R5 is selected from H and a moiety having from 1 to 10 carbons, or from 1 to 6 carbons, or from 1 to 4 carbons.

The oligoamines of the present disclosure may be considered linear oligoamines. By “linear,” it is meant that there are no further amine-containing side chains grafted on the oligoamine backbone represented by the above Formula. However, it is understood that the linear oligoamine may, at least in some cases, have alkyl groups that are attached to oligoamine backbone, such as methyl or ethyl groups.

Depending on the product type and/or overall benefit space desired, the formulator may select oligoamines having primary, secondary, and/or tertiary nitrogens, particularly at the terminal positions. Without wishing to be bound by theory, it is believed the presence of primary nitrogens in the present oligoamines may provide improved malodor control benefits, believed to be due to improved chelation efficiency and/or coordination to a target surface, such as a fabric. Also without wishing to be bound by theory, it is believed that tertiary nitrogens in the present oligoamines may result in fewer interactions with other materials in the treatment composition, for example reactions with certain perfume materials that may otherwise result in Schiff base reactions and consequent colour changes in liquid products.

Preferably, the oligoamine has a molecular weight of between 100 Da and 1200 Da, preferably between 100 Da and 900 Da, more preferably between 100 Da and 600 Da, even more preferably between 100 Da and 400 Da, even more preferably between 100 Da and 250 Da, even more preferably between 100 Da and 200 Da, more preferably between 100 Da and 150 Da. The molecular weight of the oligoamine is the weight percentage of the non-salt basic form of the polymer, in other words, the unprotonated form.

Preferably, the oligoamine is selected from diethylenetriamine (DETA), 4-methyl diethylenetriamine (4-MeDETA), dipropylenetriamine (DPTA), 5-methyl dipropylenetriamine (5-MeDPTA), triethylenetetraamine (TETA), 4-methyl triethylenetetraamine (4-MeTETA), 4,7-dimethyl triethylenetetraamine (4,7-Me2TETA), 1,1,4,7,7-pentamethyl diethylenetriamine (M5-DETA), tripropylenetetraamine (TPTA), tetraethylenepentaamine (TEPA), tetrapropylenepentaamine (TPPA), pentaethylenehexaamine (PEHA), pentapropylenehexaamine (PPHA), hexaethyleneheptaamine (HEHA), hexapropyleneheptaamine (HPHA), N,N′-Bis(3-aminopropyl)ethylenediamine, or mixtures thereof.

The oligoamine may preferably be selected from diethylenetriamine (DETA), 4-methyl diethylenetriamine (4-MeDETA), 1,1,4,7,7-pentamethyl diethylenetriamine (M5-DETA), dipropylenetriamine (DPTA), 5-methyl dipropylenetriamine (5-MeDPTA), triethylenetetramine (TETA), tripropylenetetraamine (TPTA), tetraethylenepentaamine (TEPA), tetrapropylenepentaamine (TPTA), N,N′-Bis(3-aminopropyl)ethylenediamine, and mixtures thereof, more preferably diethylenetriamine (DETA), 4-methyl diethylenetriamine (4-MeDETA), N,N′-Bis(3-aminopropyl)ethylenediamine, triethylenetetramine (TETA), tetraethylenepentaamine (TEPA), N,N′-Bis(3-aminopropyl)ethylenediamine, and mixtures thereof, even more preferably diethylenetriamine (DETA), 4-methyl diethylenetriamine (4-MeDETA), N,N′-Bis(3-aminopropyl)ethylenediamine and mixtures thereof, most preferably diethylenetriamine (DETA). DETA may be preferred due to its low molecular weight and/or relatively low cost to produce.

The oligoamine may comprise diethylene triamine (“DETA,” where m is equal to 2, n is equal to 1, and each of R¹-R⁵ is H), or a derivative thereof, including alkylated forms (e.g., where one or more of R¹-R⁵ is an alkyl group, such as methyl). The oligoamine may comprise at least 80% or even at least 90% or even at least 95% by weight of the oligoamine of a form of diethylene triamine (DETA), even more preferably the oligoamine consists of a form of diethylene triamine (DETA). The oligoamine may be selected from: DETA; 4-methyl DETA; 1,1,4,7,7-pentamethyl DETA; and mixtures thereof; preferably DETA (unalkylated diethylene triamine).

Preferably, the oligoamine comprises at least 80%, more preferably at least 90%, even more preferably at least 95%, most preferably 100% by weight of the oligoamine of diethylene triamine (DETA).

Depending on the finished product or wash solution pH, the nitrogen atoms may be (partially) protonated, resulting in the salt form of the oligoamine according to the above formula. These (partially) protonated oligoamines are also considered as part of the scope of the invention.

A skilled person in the art will know how to obtain oligoamines according to the present disclosure. For example, oligoamines according to the above Formula where L has m equal to 2 may be obtained by reactions involving ammonia and ethylene dichloride, followed by fractional distillation. The common oligoamines obtained are diethylenetriamine (DETA), triethylenetetramine (TETA), and tetraethylenepentamine (TEPA). Other oligoamines according to Formula I may be formed, where m is equal to from 2 to 6 via use of the appropriate halogen-disubstituted alkylenes.

Above the pentamines, i.e the hexamines, heptamines, octamines, and possibly nonamines, the cogenerically derived mixture does not appear to separate by distillation and can include other materials such as cyclic amines and particularly piperazines.

Suitable ethylene-based oligoamines according to the present disclosure are commercially available from multiple chemical suppliers including Dow, BASF, Huntsman, and Akzo Nobel Corporations.

Preferably, the laundry detergent composition comprises from 0.01% to 5%, more preferably from 0.03% to 1%, even more preferably from 0.05% to 0.5%, most preferably from 0.05% to 0.2% by weight of the laundry detergent composition of the oligoamine Without wishing to be bound by theory, at these preferred ranges, unwanted fabric yellowing during the wash is minimized

### Process of Making

Those skilled in the art will know how to make a water-soluble unit dose article and laundry detergent composition according to the present disclosure using techniques known in the art.

### Use

A further aspect of the present disclosure is a use of an oligoamine or salt thereof to reduce malodours on fabrics wherein the fabric comprises at least one source of malodour and the oligoamine is according to the following formula;

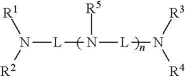

wherein

each L is independently —(CₘH₂ₘ)—, wherein the index m is independently for each L an integer from 2 to 6, preferably m is 2 or 3, more preferably m is 2 (e.g., ethylene groups);

n is an integer from 1 to 10 (i.e. triamines, tetramines, pentamines, hexamines, heptamines), preferably from 1 to 5, more preferably from 1 to 3, even more preferably from 1 to 2, most preferably 1; and

wherein each of R¹-R⁵ is independently selected from H and C₁-C₄ alkyl, preferably H and methyl (i.e., C₁ alkyl).

The index m may be independently for each L an integer from 2 to 6, wherein the index m is 2 or 3, preferably 2, for each of two L groups that are directly connected to a common N atom. It is believed that having two such L groups adjacent to a common N atom will facilitate improved metal sequestration, even if other L groups are relatively larger.

Each of R¹-R⁵ may be H. R⁵ may be methyl. R⁵ may be H. One or both of R¹ and R³ may be methyl. R¹ and R³ may be methyl, and R² and R⁴ may both be hydrogen. Each of R¹-R⁵ may be methyl. Most preferably each of R¹-R⁵ are H.

The oligoamine or salt thereof is as described above in the section titled ‘oligoamine’.

The wash liquor comprises a metal ion, preferably Cu²⁺. The metal ion may be present on the fabric before the fabric is contacted with the wash liquor. The metal ion may be present in the source of malodour on the fabric before the fabric is combined to the wash liquor. The metal ion may be present in the wash liquor when combined with the fabric. If present in the wash liquor, the metal ion may be present in the laundry detergent, the water or a mixture thereof. The source of malodour may comprise the metal ion at the point the source of malodour is applied to the fabric. Alternatively, the source of malodour may be applied to the fabric and the metal ion applied later.

Preferably, the at least one source of malodour comprises a metal ion, more preferably Cu²⁺.

A further aspect of the present invention is the use of a process according to the present invention to reduce malodour on fabrics in a wash liquor and wherein the fabrics comprise at least one source of malodour and wherein the wash liquor comprises a metal ion, preferably Cu⁺.

### EXAMPLES

### Malodor Removal Washing Test

The objective of the malodor removal washing test is to cross-compare the ability of different wash processes to reduce malodour on fabrics. A malodor cocktail is applied on laundry items to be washed in a subsequent full scale washing scale, after which the amount of remaining malodor actives on dried fabrics is analytically determined through GC-MS headspace SPME analysis. Each product is tested on 4 different washing machines, each washing machine comprising 16 malodor tracers (hence 64 replicates in total), and individual results are averaged and reported.

1) Washing Step:
Washing machine: High Efficiency Front Loading machine (Duet9200)
Washing cycle: normal cycle, 19.6 L water in wash cycle, 7 gpg, 25° C., 3.9 kg mixed cotton/polycotton ballast load (50×50 cm knit swatches: 17 cotton/12 polycotton), 16 malodor tracers (2×5 inch polycotton (50/50) swatches)
Washing product: one soluble unit dose comprising 25.4 g of test detergent

2) Drying Step:
Drying machine: Maytag Double Stack
Drying cycle: 20 minutes at 60-65° C. (setting: LOW)—16 washed malodor tracers together with 4 clean, dry hand towels
Storage: dried swatches are placed in a Mylar bag (Polyester resin coated aluminum bags used to store fabrics until evaluation) sealed with a heat sealer for storage prior to analytical testing.
   The water used to create the wash liquor contains 50 ppb of Cu²⁺.

3) Analytical Malodor Characterization:

The principle behind the analytical malodor characterization technique is that the physical properties of malodor components require the component to have a low vapor pressure and/or a low odor detection threshold. Having these properties allows for the malodor to partition into the headspace. Therefore, headspace measurements above fabrics can be made to determine the amount of malodor on a fabric swatch.

The analysis is conducted with a Gas Chromatograph 7890B equipped with a Mass Selective Detector (MSD) (5977B) and Chemstation quantitation package, connected with a Gerstel Multi-Purpose sampler equipped with a solid phase micro-extraction (SPME) probe and with a DB-FFAP column Agilent part #122-3232. A Divinylbenzene/Carboxen/Polydimethylsiloxane SPME fiber from Supleco part #57298-U (or similar fiber) is used.

A malodor tracer is cut to a 2″×2.5″ piece and placed in a 10 mL headspace crimp vial (Restek—part #21165-221). The tracer is allowed to equilibrate for 12 hours in the vial prior to GC-MS headspace SPME analysis.

GC-MS Parameters:

### Gerstel Auto Sampler Parameters

SPME: from Incubator
Incubation Temperature: 80° C.
Incubation Time: 90.00 min
Sample Tray Type: VT32-10
Vial Penetration: 22.00 mm
Extraction Time: 20.00 min
Inj. Penetration: 54.00 mm
Desorption Time: 300 s

### GC Oven Parameter

Front SS Inlet He
   Mode Split
   Heater: 250° C.
   Pressure: 11.962 psi
   Total Flow: 79.5 mL/min
   Septum Purge Flow: 3 mL/min
   Split Ratio: 50:1
   GC Run Time: 22.5 min
Oven
   Initial temperature: 40° C.
   Hold Time: 0 min
   Heating Program
      Rate: 12° C./min
      Temperature: 250° C.
      Hold Time: 5 min

### MSD Parameters

Detection is run in scan mode with a minimum range of 40 to 350 m/z. A target ion for quantification is determined for each malodor component along with a minimum of 1 qualifier ion, preferably 2. The defined target and qualifier ions for each component must be based on an MSD compound library or standard.

Calibration curves are generated from standards in mineral oil for each malodor material. Utilizing the calibration headspace response, the integration of the extracted ion (EIC) for each malodor component in the test samples is plotted or recorded and averaged across replicates.

Artificial body soil (ABS)-squalene oxidation markers have been specifically analyzed for and are summarized together in the data shown below. More specifically ABS-squalene oxidation markers used are 3-methylbutenal, 2-heptenal and 6-methyl-5-hepten-2-one.

### Materials:

1) Preparation Malodor Tracers:

Malodor tracers are prepared by applying the freshly made malodor cocktail to polycotton (PC) (50/50) swatches in which fabric finishes applied to fabrics at the textile mill that could potentially cause interference are removed. The malodor cocktail is applied to 2×5 inch polycotton 50/50 swatches the same morning as the full scale runs are conducted. PC 50/50 swatches are supplied by APD (Accurate Product Development, global materials supplier located in Cincinnati, Ohio).

An Integra Viaflo Automatic Pipette is used to apply the malodor cocktail on the PC 50/50 swatches. A 96-channel head (8 rows of 12 tips) and 300 μl pipette tips are used. For this test 5 rows of 12 tips are used to apply the malodor cocktail on a fabric tracer. Each tip applies 15 μl on the fabric tracer. 16 malodor cocktail comprising fabric tracers are prepared and wrapped together in an Aluminium foil for storage till beginning of the washing test.

2) Malodor Cocktail Composition:

The following malodor cocktail has been prepared through mixing of the individual compounds:

| | Order Of | |
|---|---|---|
| Malodor cocktail | Addition | weight (g) |
| Malodor core (see below) | 1 | 29.25 |
| ABS from APD | 2 | 27 |
| Squalene (CAS: 111-02-4) | 3 | 27 |

| | | Order Of | |
|---|---|---|---|
| Malodor core | CAS-number | Addition | % Comp |
| Undecanoic Acid | 112-37-8 | 1 | 62.80 |
| Decanoic Acid | 334-48-5 | 2 | 22.00 |
| Skatole | 83-34-1 | 3 | 1.00 |
| Iso Valeric acid | 503-74-2 | 4 | 12.00 |
| Ethyl undecanoate | 627-90-7 | 5 | 2.00 |
| Undecanal | 112-44-7 | 6 | 0.20 |

3) Detergent Compositions:

Water soluble unit dose compositions comprising 25.4 g of test detergent compositions enclosed in a 76 μm PVA water soluble film provided by Monosol, have been made by mixing of individual components followed by enclosing the liquid detergent composition in a water soluble film.

| | Nil | Example 1 | Example 2 |
|---|---|---|---|
| | DETA | (0.1% | (0.5% |
| Formula 100% active | Reference | DETA) | DETA) |
| Usage (g) (nil PVA film) | 25.4 | 25.4 | 25.4 |
| Usage (ml) | 23.7 | 23.7 | 23.7 |
| Ingredient Name | WT % | WT % | WT % |
| Surfactants | | | |
| Nonionic surfactant (C45EO7) | 3.1 | 3.1 | 3.1 |
| Nonionic surfactant (C24EO9) | 0.9 | 0.9 | 0.9 |
| Anionic surfactant (HLAS) | 23.2 | 23.2 | 23.2 |
| Anionic surfactant | 15.9 | 15.9 | 15.9 |
| (C25AE2.5S) | | | |
| Builders | | | |
| Citric acid | 0.9 | 0.9 | 0.9 |
| Fatty Acid | 6.4 | 6.4 | 6.4 |
| Performance additives | | | |
| Ethoxylated polyethyleneimine | 3.5 | 3.5 | 3.5 |
| (PEI600EO20)* | | | |
| Amphiphilic graft polymer** | 2.2 | 2.2 | 2.2 |
| DETA | — | 0.1 | 0.5 |
| Na-DTPA (Dissolvine D50) | 0.9 | 0.9 | 0.9 |
| chelant | | | |
| Brightener 49 (8.4% premix) | 0.2 | 0.2 | 0.2 |
| Hueing dye (Violet 200) | 0.04 | 0.04 | 0.04 |
| Stabilizers/Solvent | | | |
| 1,2 PropaneDiol | 12.2 | 12.1 | 11.7 |
| Glycerine | 4.1 | 4.1 | 4.1 |
| DPG/TPG | 4.4 | 4.4 | 4.4 |
| MEA (MonoEthanolAmine) | 8.6 | 8.6 | 8.6 |
| water | 9.8 | 9.8 | 9.8 |
| Hydrogenerated Castor Oil | 0.1 | 0.1 | 0.1 |
| Others | | | |
| Minors (perfume, dye, | Balance | Balance | Balance |
| enzymes - | to 100 | to 100 | to 100 |
| protease/amylase/mannanase- | | | |
| preservative, anti-oxidant, anti-foam), | | | |

*polyethylene glycol graft polymer comprising a polyethylene glycol backbone (Pluriol E6000) and hydrophobic vinyl acetate side chains, comprising 40% by weight of the polymer system of a polyethylene glycol backbone polymer and 60% by weight of the polymer system of the grafted vinyl acetate side chains
**ethoxylated polyethyleneimine having an average degree of ethoxylation of 20 per EO chain and a polyethyleneimine backbone with MW of about 600

Test Results:

The data shown in the table below show a significant reduction in oxidative bi-products of ABS and squalene for both Example formulations respectively comprising 0.1% and 0.5% of DETA, a oligoamine according to the invention formulated on top of a nil oligoamine reference product, versus this nil oligoamine comprising reference formulation.

The significant reduction in oxidative bi-products of ABS and squalene indicates a significantly improved malodor reduction profile for the example versus the reference formulations.

| | Nil DETA | Example 1 | Example 2 |
|---|---|---|---|
| | Reference | (0.1% DETA) | (0.5% DETA) |
| ABS-squalene oxidation | 49 mmol/L | 20 mmol/L | 6 mmol/L |
| markers | headspace | headspace | headspace |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process of reducing malodours on fabrics, comprising the steps of:
a. combining fabrics with a wash liquor, wherein the fabrics comprise at least one source of malodour and wherein the wash liquor comprises a source of metal ions, preferably Cu²⁺ and wherein the wash liquor is prepared by diluting a laundry detergent composition in water by a factor of between about 100 and about 3000 fold;
b. washing the fabrics in the wash liquor using an automatic wash operation, a manual wash operation or a mixture thereof;
c. separating the fabrics and the wash liquor from one another;
d. drying the fabrics;
wherein the laundry detergent composition comprises from about 0.01% to about 5%, by weight of the laundry detergent composition of an oligoamine or salt thereof, wherein the oligoamine has the following formula: 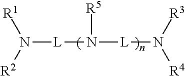
wherein:
each L is independently —(CₘH₂ₘ)—, wherein the index m is independently for each L an integer from about 2 to about 6;
n is an integer from about 1 to about 10; and
each of R¹-R⁵ is independently selected from H and C₁-C₄ alkyl.

2. The process according to claim 1, wherein the oligoamine has a molecular weight of between about 100 Da and about 1200 Da.

3. The process according to claim 1, wherein the metal ion is introduced to the wash liquor by being present on the fabric prior to contacting with the wash liquor, being present in the water used to make the wash liquor, or a mixture thereof.

4. The process according to claim 1:
a. wherein the fabrics are washed in the wash liquor at a temperature of between about 10° C. and about 60° C.;
b. wherein the wash operation in step b takes between about 5 minutes and about 60 minutes;
c. or a mixture thereof.

5. The process according to claim 1 wherein the oligoamine is selected from the group consisting of diethylenetriamine (DETA), 4-methyl diethylenetriamine (4-MeDETA), dipropylenetriamine (DPTA), 5-methyl dipropylenetriamine (5-MeDPTA), triethylenetetraamine (TETA), 4-methyl triethylenetetraamine (4-MeTETA), 4,7-dimethyl triethylenetetraamine (4,7-Me₂TETA), 1,1,4,7,7-pentamethyl diethylenetriamine (M5-DETA), tripropylenetetraamine (TPTA), tetraethylenepentaamine (TEPA), tetrapropylenepentaamine (TPPA), pentaethylenehexaamine (PEHA), pentapropylenehexaamine (PPHA), hexaethyleneheptaamine (HEHA), hexapropyleneheptaamine (HPHA), N,N′-Bis(3-aminopropyl)ethylenediamine, and mixtures thereof.

6. The process according to claim 1 wherein the wash liquor comprises from about 0.1 ppm to about 100 ppm of the oligoamine.

7. The process according to claim 6 wherein the wash liquor comprises from about 0.15 ppm to about 50 ppm of the oligoamine.

8. The process according to claim 1 wherein the laundry detergent composition comprises a non-soap surfactant.

9. The process according to claim 8 wherein the laundry detergent composition comprises between about 10% and about 60% by weight of the laundry detergent composition of the non-soap surfactant.

10. The process according to claim 8 wherein the non-soap surfactant comprises linear alkylbenzene sulphonate, alkoxylated alkyl sulphate or a mixture thereof.

11. The process according to claim 10 wherein the non-soap surfactant comprises a mixture of linear alkylbenzene sulphonate and alkoxylated alkyl sulphate, wherein the weight ratio of linear alkylbenzene sulphonate to alkoxylated alkyl sulphate is from about 1:2 to about 20:1.

12. The process according to claim 9 wherein the non-soap surfactant comprises non-soap anionic surfactant, and wherein the laundry detergent composition comprises between about 5% and about 50%, by weight of the detergent composition, of the non-soap anionic surfactant.

13. The process according to claim 9 wherein the laundry detergent composition comprises between about 0% and about 10% by weight of the laundry detergent composition of a non-ionic surfactant.

14. The process according to claim 13 wherein the non-ionic surfactant is selected from alcohol alkoxylate, an oxo-synthesised alcohol alkoxylate, Guerbet alcohol alkoxylates, alkyl phenol alcohol alkoxylates, or a mixture thereof.

15. The process according to claim 1 wherein the water-soluble unit dose article comprises between about 1.5% and about 20% by weight of the laundry detergent composition of soap.

16. The process according to claim 15 wherein the soap is an amine neutralized fatty acid salt.

17. The process according to claim 1 wherein the laundry detergent comprises an ingredient selected from the group consisting of cationic polymers, polyester terephthalates, amphiphilic graft co-polymers, carboxymethylcellulose, enzymes, perfumes, encapsulated perfumes, bleach, or a mixture thereof.

18. The process according to claim 1 wherein the laundry detergent composition comprises a chelant.

19. The process according to claim 1 wherein the laundry detergent composition comprises an antioxidant.

20. The process according to claim 1 wherein the laundry detergent composition is a liquid and wherein the liquid laundry detergent composition has a pH between about 6 and about 10, wherein the pH of the liquid laundry detergent composition is measured as a 10% dilution in demineralized water at 20° C.
